(19) United States
(12) Patent Application Publication
(10) Pub. No.: US 2026/0084428 A1
(43) Pub. Date: Mar. 26, 2026

(54) INKJET RECORDING APPARATUS

(71) Applicant: KYOCERA Document Solutions Inc., Osaka (JP)

(72) Inventor: Rikuto Shimomura, Osaka (JP)

(21) Appl. No.: 19/328,992

(22) Filed: Sep. 15, 2025

(30) Foreign Application Priority Data
Sep. 26, 2024 (JP) 2024-166907

(51) Int. Cl. B41J 2/165; B41J 2/175; B41J 25/316; B41J 29/00

(52) U.S. Cl. CPC B41J 2/16508; B41J 2/175; B41J 25/316; B41J 29/00

(57) ABSTRACT

An inkjet recording apparatus includes an ink supply device, an inkjet head, and a head driving device. The inkjet head is arranged above a sheet conveying path and has a storage portion that temporarily stores ink supplied by the ink supply device and a plurality of nozzles that eject the ink supplied from the storage portion onto a sheet conveyed along a first direction. The head driving device pivots the inkjet head around a pivot shaft along a second direction crossing the first direction between a first posture in which the plurality of nozzles face the sheet conveying path and a second posture in which the plurality of nozzles face upward.

### INCORPORATION BY REFERENCE

This application is based upon and claims the benefit of priority from the corresponding Japanese Patent Application No. 2024-166907 filed on September 26, 2024, the entire contents of which are incorporated herein by reference.

### BACKGROUND

The present disclosure relates to an inkjet recording apparatus equipped with an inkjet head that temporarily stores ink and ejects the ink from a plurality of nozzles.

An inkjet recording apparatus forms an image on a sheet by ejecting ink from a plurality of nozzles onto the sheet. The inkjet recording apparatus has a storage portion that temporarily stores the ink, and a plurality of nozzles that eject the ink supplied from the storage portion.

In the inkjet head, air bubbles may occur in the storage portion. The air bubbles in the storage portion adversely affect the ejection of the ink.

For example, it is known that in order to prevent the air bubbles from being generated in the storage portion, the inkjet head may form a meniscus at an opening having a smaller opening area than the plurality of nozzles.

### SUMMARY

An inkjet recording apparatus according to a first aspect of the present disclosure includes an ink supply device, an inkjet head, and a head driving device. The ink supply device supplies ink. The inkjet head is arranged above a sheet conveying path and has a storage portion that temporarily stores ink supplied by the ink supply device and a plurality of nozzles that eject the ink supplied from the storage portion onto a sheet conveyed along a first direction of the sheet conveying path. The head driving device pivots the inkjet head around a pivot shaft along a second direction crossing the first direction between a first posture in which the plurality of nozzles face the sheet conveying path and a second posture in which the plurality of nozzles face upward.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to an embodiment.

FIG. 2 is a cross-sectional view of an inkjet head in an inkjet recording apparatus according to an embodiment.

FIG. 3 is a block diagram showing a configuration of a control device in an inkjet recording apparatus according to an embodiment.

FIG. 4 is a diagram showing a configuration of a head driving device in an inkjet recording apparatus according to an embodiment.

FIG. 5 is a diagram showing an inkjet head held in a first posture at a retreat position, and a nozzle cover device in a nozzle open state in an inkjet recording apparatus according to an embodiment.

FIG. 6 is a diagram showing an inkjet head held in a second posture at a retreat position, and a nozzle cover device in a nozzle open state in an inkjet recording apparatus according to an embodiment.

FIG. 7 is a diagram showing a nozzle cover device in a first nozzle closed state in an inkjet recording apparatus according to an embodiment.

FIG. 8 is a diagram showing an inkjet recording apparatus when a nozzle cover device is in a first nozzle closed state.

FIG. 9 is a diagram showing a nozzle cover device in a second nozzle closed state in an inkjet recording apparatus according to an embodiment.

FIG. 10 is a diagram showing an inkjet recording apparatus when a nozzle cover device is in a second nozzle closed state.

### DETAILED DESCRIPTION

Hereinafter, embodiments according to the present disclosure will be described with reference to the drawings. Note that the following embodiments are examples according to the present disclosure and do not limit the technical scope of the present disclosure.

The inkjet recording apparatus 10 according to an embodiment executes an inkjet printing process for forming an image on a sheet 9 by ejecting ink R1 onto the sheet 9. A printing device 3 has a plurality of inkjet heads 31 each of which ejects ink R1 onto the sheet 9.

For example, the inkjet recording apparatus 10 is a printer, a facsimile apparatus, a copier, a multifunction peripheral, or the like. The sheet 9 is a sheet-like image forming medium such as paper or a resin film.

### CONFIGURATION OF INKJET RECORDING APPARATUS 10

The inkjet recording apparatus 10 includes a sheet storing portion 12, a sheet conveying device 2, a printing device 3 and an ink supply device 4.

The inkjet recording apparatus 10 further includes an operation device 801, a display device 802, a control device 8, and the like.

The sheet conveying device 2, the printing device 3, the ink supply device 4, and the control device 8 are housed in a main body 11 of the inkjet recording apparatus 10.

The sheet conveying device 2 conveys sheets 9 stored in the sheet storing portion 12 one by one along a sheet conveying path 20. Furthermore, the sheet conveying device 2 feeds out a sheet 9 on which an image has been formed by the printing device 3 from the sheet conveying path 20. For example, the sheet conveying device 2 feeds out a sheet 9 from the sheet conveying path 20 to a discharge tray or another device at a downstream stage.

The sheet conveying device 2 includes a sheet feeding portion 21, a plurality of sets of conveying roller pairs 22, a first belt conveying unit 23, a second belt conveying unit 24, a feeding roller pair 25, and the like. The sheet feeding portion 21 feeds out sheets 9 one by one from the sheet storing portion 12 to the sheet conveying path 20.

The plurality of sets of conveying roller pairs 22 take over the conveying of the sheet 9 from the sheet feeding portion 21 and convey the sheet 9 toward the first belt conveying unit 23.

The first belt conveying unit 23 is arranged below the printing device 3. The first belt conveying unit 23 conveys the sheet 9 in a predetermined conveying direction D0.

In the following description, a direction along the conveying direction D0 is referred to as a first direction D1, and a direction crossing the first direction D1 is referred to as a second direction D2. In the present embodiment, the second direction D2 is a direction perpendicular to the first direction D1.

In the printing device 3, the second direction D2 is a main scanning direction, and the first direction D1 is a sub-scanning direction.

In the first belt conveying unit 23, a plurality of tension rollers 231 support and rotate an endless first conveying belt 230. Thus, an upper surface of the first conveying belt 230 moves in the conveying direction D0. The first belt conveying unit 23 conveys the sheet 9 on the upper surface of the first conveying belt 230.

Furthermore, the first belt conveying unit 23 feeds out the sheet 9 from the upper surface of the first conveying belt 230 to the second belt conveying unit 24.

The second belt conveying unit 24 is arranged on a downstream side of the first belt conveying unit 23 in the conveying direction D0.

In the second belt conveying unit 24, a plurality of tension rollers 241 support and rotate an endless second conveying belt 240. Thus, an upper surface of the second conveying belt 240 moves in the conveying direction D0. The second belt conveying unit 24 conveys the sheet 9 on the upper surface of the second conveying belt 240.

Further, the second belt conveying unit 24 feeds out the sheet 9 to a feeding roller pair 25. Note that the inkjet recording apparatus 10 may also include a drying device (not shown). The drying device dries the ink R1 on the sheet 9 conveyed by the second belt conveying unit 24.

The feeding roller pair 25 is arranged on a downstream side of the second belt conveying unit 24 in the conveying direction D0. The feeding roller pair 25 feeds out the sheet 9 on which an image is formed to outside of the main body 11.

The ink supply device 4 supplies ink R1 of different colors to the plurality of inkjet heads 31. The ink supply device 4 includes a plurality of ink tanks 41 and an ink feeding device 42.

Each of the plurality of ink tanks 41 contains a different color of ink R1. The ink feeding device 42 feeds the ink R1 from each of the plurality of ink tanks 41 to the plurality of inkjet heads 31.

In the present embodiment, the printing device 3 includes four inkjet heads 31 corresponding to four colors of ink R1: black, cyan, magenta, and yellow. In addition, the ink supply device 4 also includes four ink tanks 41 corresponding to the four colors of ink R1.

### Inkjet Head 31

The four inkjet heads 31 are arranged side by side in the first direction D1. Each of the inkjet heads 31 is arranged with a longitudinal direction thereof aligned along the second direction D2.

The four inkjet heads 31 are arranged above the upper surface of the first conveying belt 230. Each of the inkjet heads 31 has an ink ejection portion 31A and a storage portion 31B (see FIG. 2).

The storage portion 31B temporarily stores the ink R1 supplied by the ink supply device 4. The storage portion 31B has an inlet 31C that receives the ink R1 supplied by the ink supply device 4.

Furthermore, each inkjet head 31 has a pressure adjusting valve 31D that adjusts the pressure in the storage portion 31B (see FIG. 2). The pressure adjusting valve 31D is a negative pressure adjusting valve that introduces outside air into the storage portion 31B when the pressure in the storage portion 31B falls below a lower limit pressure. The lower limit pressure is a negative pressure. When the pressure adjusting valve 31D is operated, air bubbles are likely to occur in the storage portion 31B.

The ink ejection portion 31A includes a plurality of nozzles 32 each capable of ejecting the ink (see FIG. 2). The plurality of nozzles 32 are arranged along the second direction D2.

The inlet 31C and the pressure adjusting valve 31D are provided on a surface of each inkjet head 31 opposite to a surface on which the plurality of nozzles 32 are formed (see FIG. 2).

The plurality of nozzles 32 eject the ink R1 supplied from the storage portion 31B onto the sheet 9 being conveyed on the upper surface of the first conveying belt 230 in the first direction D1. In the present embodiment, the upper surface of the first conveying belt 230 is a part of the sheet conveying path 20.

Furthermore, the ink ejection portion 31A includes a plurality of piezoelectric elements 33, a plurality of pressure chambers 35, and a plurality of vibration plates 34 (see FIG. 2). The plurality of piezoelectric elements 33, the plurality of pressure chambers 35 and the plurality of vibration plates 34 are provided corresponding to the plurality of nozzles 32.

The storage portion 31B is connected to the plurality of pressure chambers 35. The ink R1 is temporarily stored in the storage portion 31B, and then is supplied from the storage portion 31B to the plurality of pressure chambers 35.

The plurality of pressure chambers 35 are connected to the plurality of nozzles 32. That is, the storage portion 31B is connected to the plurality of nozzles 32 via the plurality of pressure chambers 35.

The plurality of pressure chambers 35 form passages for ink to be supplied to the plurality of nozzles 32. The ink R1 is temporarily stored in the storage portion 31B, and then supplied from the storage portion 31B to the plurality of nozzles 32 via the plurality if pressure chambers 35.

The plurality of vibration plates 34 each form a part of a partition wall of the plurality of pressure chambers 35. When a drive signal is supplied to each of the piezoelectric elements 33, the piezoelectric elements 33 pressurize the ink in the pressure chambers 35 via the vibration plates 34.

The drive signal is supplied from the control device 8 to each of the piezoelectric elements 33. By the drive signal being supplied to each of the piezoelectric elements 33 from the control device 8, the piezoelectric elements 33 pressurize the ink supplied to each of the plurality of nozzles 32.

The piezoelectric element 33 to which the drive signal is supplied vibrates with energy that causes ink to be ejected from the corresponding nozzle 32. The ink pressurized by the piezoelectric element 33 to which the drive signal is supplied flows from the pressure chamber 35 into the corresponding nozzle 32 and is then ejected from the nozzle 32. The plurality of nozzles 32 form an image on the sheet 9 by ejecting ink onto the sheet 9.

The operation device 801 is a device that receives operations by a person. For example, the operation device 801 includes operation buttons and a touch panel. The display device 802 is capable of displaying information. For example, the display device 802 includes a display panel such as a liquid crystal panel.

### Control Device 8

The control device 8 executes various types of data processing and controls devices included in the inkjet recording apparatus 10.

As shown in FIG. 2, the control device 8 includes a central processing unit (CPU) 81, a random access memory (RAM) 82, a secondary storage device 83, a signal interface 84, a communication device 85, and the like.

The CPU 81 is an example of a processor that executes various types of data processing and control by executing computer programs.

The RAM 82 is a computer-readable volatile storage device. The RAM 82 temporarily stores the computer programs executed by the CPU 81 and data output and referenced by the CPU 81 in the course of executing various types of processes.

The secondary storage device 83 is a computer-readable non-volatile storage device. The secondary storage device 83 is capable of storing and updating the computer programs and various types of data. For example, some or all of a flash memory, a solid state drive (SSD), and a hard disk drive are employed as the secondary storage device 83.

The signal interface 84 converts signals output by various types of sensors into digital data, and transmits the converted digital data to the CPU 81. Furthermore, the signal interface 84 converts the control command output by the CPU 81 into a control signal, and transmits the control signal to a device to be controlled.

The communication device 85 is capable of communicating with a host device and other devices (not shown). The host device is an information processing apparatus such as a personal computer or a smartphone operated by a user.

For example, the CPU 81 receives a printing job from the host device through the communication device 85. The printing device 3 forms an image specified by the printing job on the sheet 9.

Furthermore, the control device 8 includes a drive circuit 86. The drive circuit 86 receives the control signal from the CPU 81 via the signal interface 84. The drive circuit 86 generates the drive signals corresponding to the plurality of piezoelectric elements 33 respectively in accordance with contents of the control signal, and supplies the generated drive signals to the plurality of piezoelectric elements 33. Each nozzle 32 ejects an amount of ink R1 according to the drive signal.

The CPU 81 includes a plurality of processing modules that are achieved by executing the computer programs. The plurality of processing modules include a main control portion 8a and a printing control portion 8b.

The main control portion 8a executes control to start various types of processes in response to operations on the operation device 801, control of the display device 802, and the like.

The printing control portion 8b causes the sheet conveying device 2 to execute a sheet conveying process. Furthermore, the printing control portion 8b causes the printing device 3 to execute the printing process in synchronization with the conveying of the sheet 9 by the sheet conveying device 2.

The printing control portion 8b controls the plurality of piezoelectric elements 33 via a drive circuit 86, thereby causing the printing device 3 to execute the printing process.

When temperature of the ink R1 decreases, viscosity of the ink R1 increases. In a case in which the viscosity of the ink supplied to each of the nozzles 32 is high, ejection performance of the ink from each of the nozzles 32 deteriorates when each of the piezoelectric elements 33 operates.

In the present embodiment, each inkjet head 31 includes a heater 36 for heating the ink ejection portion 31A, and a temperature sensor 37 (see FIG. 2). That is, a heater 36 and a temperature sensor 37 are arranged in each inkjet head 31.

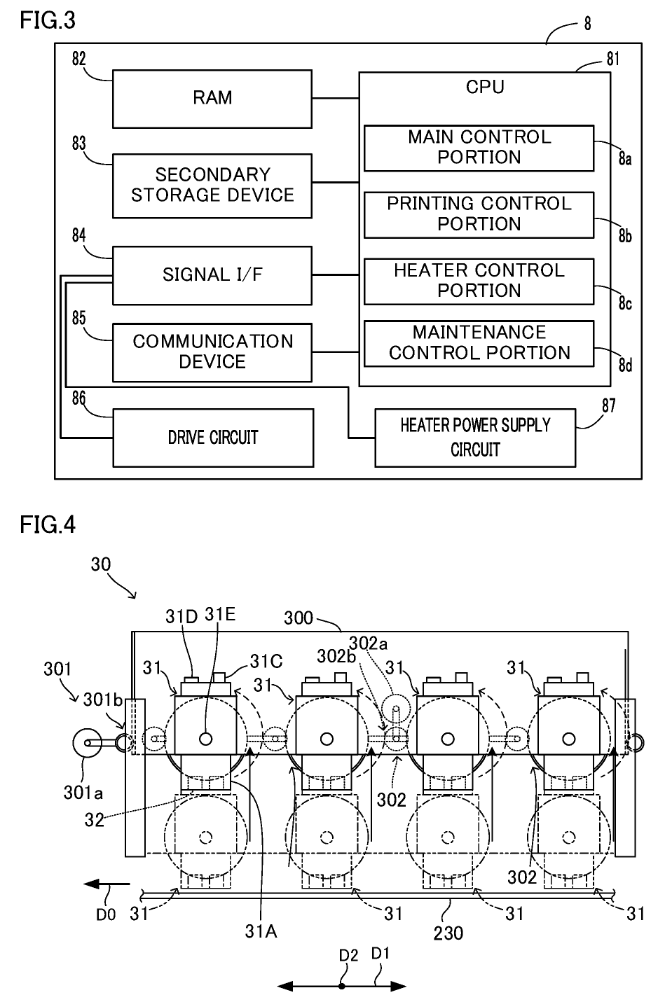

Furthermore, the control device 8 includes a heater power supply circuit 87 that supplies power to the heater 36 (see FIG. 3).

Further, the plurality of processing modules in the CPU 81 includes a heater control portion 8c (see FIG. 3). The heater control portion 8c controls the heater 36 via the heater power supply circuit 87.

The heater control portion 8c operates the heater 36, thereby shortening the first print time. The first print time is the time from when the inkjet recording apparatus 10 receives a printing request until when the inkjet recording apparatus 10 starts the printing process.

The temperature sensor 37 detects the temperature of the ink ejection portion 31A. That is, the temperature sensor 37 detects the temperature of the inkjet head 31. For example, the temperature sensor 37 is a thermistor.

The heater control portion 8c controls the heater 36 by feedback control based on the temperature detected by the temperature sensor 37 and a target temperature.

In each inkjet head 31, air bubbles may occur in the storage portion 31B. The air bubbles in the storage portion 31B adversely affect the ejection of the ink R1.

In each inkjet head 31, it is desirable to be able to discharge the air bubbles from the storage portion 31B when the air bubbles occur in the storage portion 31B. In the following description, the process of discharging the air bubbles inside the storage portion 31B of each inkjet head 31 is referred to as an air bubble discharging process.

In addition, when the inkjet recording apparatus 10 is shipped, the storage portion 31B may be filled with a storage liquid. In this case, before the printing process is executed, a process is performed to replace the storage liquid in the storage portion 31B with the ink R1.

On the other hand, before the inkjet recording apparatus 10 is transported, a process of replacing the ink R1 in the storage portion 31B with the storage liquid may be performed. In the following description, the process of replacing one of the ink R1 and the storage liquid in the storage portion 31B with the other is referred to as a stored liquid replacement process.

When the ink R1 or the storage liquid is filled in the storage portion 31B, it is desirable to reliably perform the stored liquid replacement process so that the original liquid does not remain in the storage portion 31B.

The inkjet recording apparatus 10 includes a configuration for reliably performing the air bubble discharging process or the stored liquid replacement process. The configuration will be described below.

### Head Driving Device 30

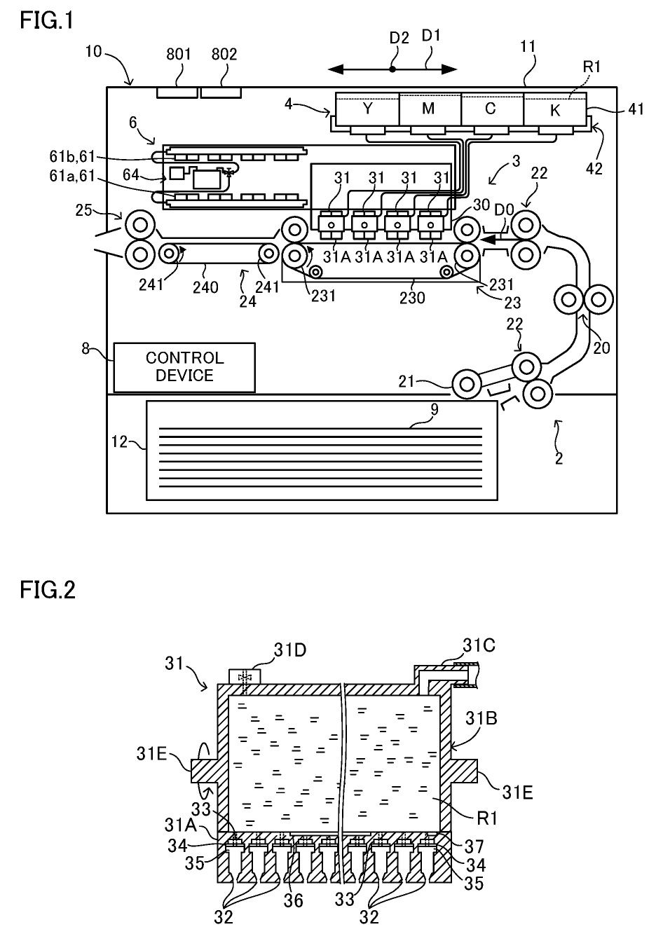

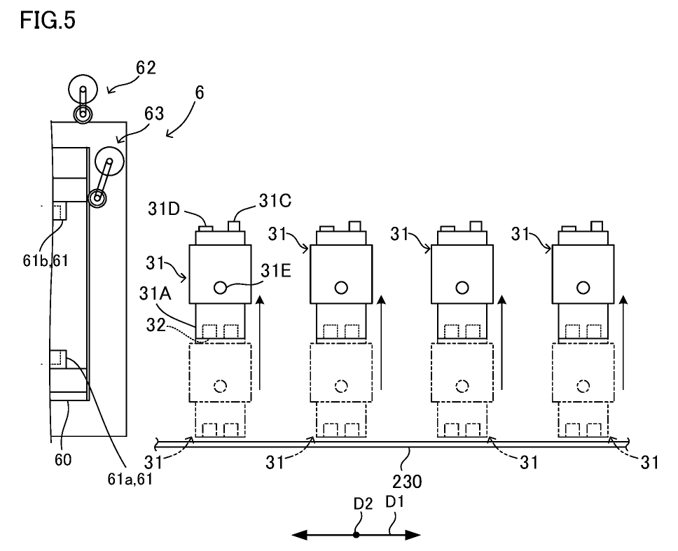

The inkjet recording apparatus 10 includes a head driving device 30 that oscillates each of a plurality of inkjet heads 31 (see FIG. 1 and FIG. 4).

Each inkjet head 31 is supported so as to be able to pivot about a respective pivot shaft 31E extending along the second direction D2 (see FIG. 2 and FIG. 4). For example, each of the inkjet heads 31 has a pivot shaft 31E (see FIG. 2).

The head driving device 30 causes each of the inkjet heads 31 to pivot about each of the pivot shafts 31E between a first posture and a second posture.

The first posture is a posture of each inkjet head 31 when the plurality of nozzles 32 face the upper surface of the first conveying belt 230 (see FIG. 4 and FIG. 5). Each of the inkjet heads 31 ejects ink R1 onto the sheet 9 when in the first posture.

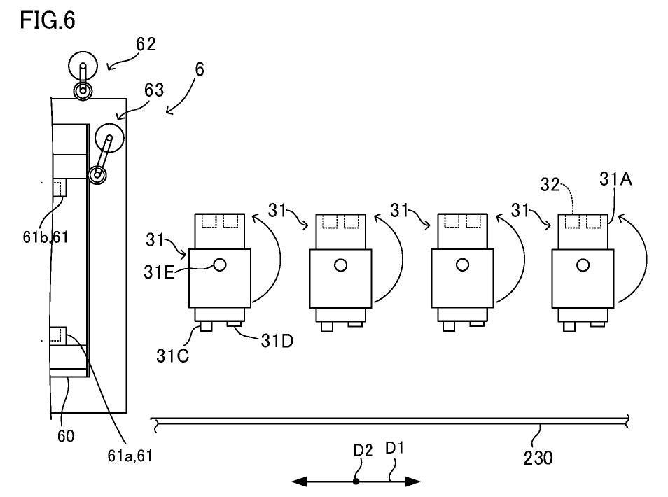

The second posture is a posture of each inkjet head 31 when the plurality of nozzles 32 face upward (see FIG. 6).

In the present embodiment, the second posture is a posture in which the plurality of nozzles 32 face vertically upward (see FIG. 6). Note that the posture of each of the inkjet heads 31 when the plurality of nozzles 32 face obliquely upward may be the second posture.

In the present embodiment, the head driving device 30 includes a head support 300, a head moving mechanism 301, and a head pivoting mechanism 302 (see FIG. 4). The head support 300 supports the plurality of inkjet heads 31. The head support 300 supports the inkjet heads 31 so that the inkjet heads 31 can pivot about the pivot shafts 31E.

The head moving mechanism 301 moves the plurality of inkjet heads 31 between a printing position and a maintenance position.

The printing position is a position of the plurality of inkjet heads 31 when the lower ends of the plurality of inkjet heads 31 are aligned along the upper surface of the first conveying belt 230 (see the inkjet heads 31 indicated by the two-dot chain lines in FIG. 4 and FIG. 5).

On the other hand, the maintenance position is a position farther from the upper surface of the first conveying belt 230 than the printing position (see the inkjet heads 31 indicated by solid lines in FIGS. 4 and 5). In the present embodiment, the head moving mechanism 301 moves the head support 300 up and down, thereby moving the plurality of inkjet heads 31 up and down.

For example, the head moving mechanism 301 includes a first motor 301a and a first gear mechanism 301b (see FIG. 4). The first gear mechanism 301b converts the rotational motion of the first motor 301a into linear motion in an up-down direction and transmits the linear motion to the head support 300.

In the example shown in FIG. 4, the first gear mechanism 301b is a rack and pinion mechanism. Depending on the rotation direction of the first motor 301a, the plurality of inkjet heads 31 move from one of the printing position and the maintenance position to the other.

The head pivoting mechanism 302 causes each of the inkjet heads 31 to pivot between the first posture and the second posture. For example, the head pivoting mechanism 302 causes each of the inkjet heads 31 to pivot when the inkjet heads 31 are in the maintenance position. When the plurality of inkjet heads 31 are moving from one of the printing position and the maintenance position to the other, the head pivoting mechanism 302 may cause each of the inkjet heads 31 to pivot.

For example, the head pivoting mechanism 302 includes a second motor 302a and a second gear mechanism 302b, each of which is supported by the head support 300 (see FIG. 4). The second gear mechanism 302b transmits rotational motion of the second motor 302a to the pivot shafts 31E of the plurality of inkjet heads 31.

Depending on the rotation direction of the second motor 302a, each of the inkjet heads 31 pivots from one of the first posture and the second posture to the other.

FIG. 5 shows the plurality of inkjet heads 31 that were held in the first posture at the maintenance position. FIG. 6 shows the plurality of inkjet heads 31 that were held in the second posture at the maintenance position.

### Nozzle Cover Device 6

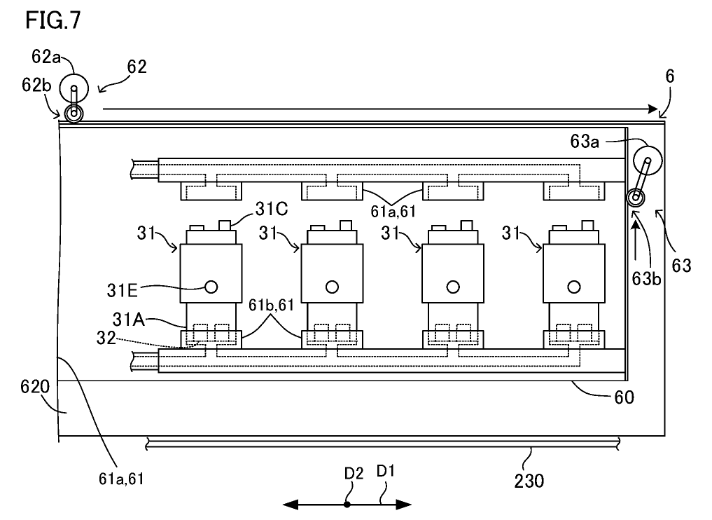

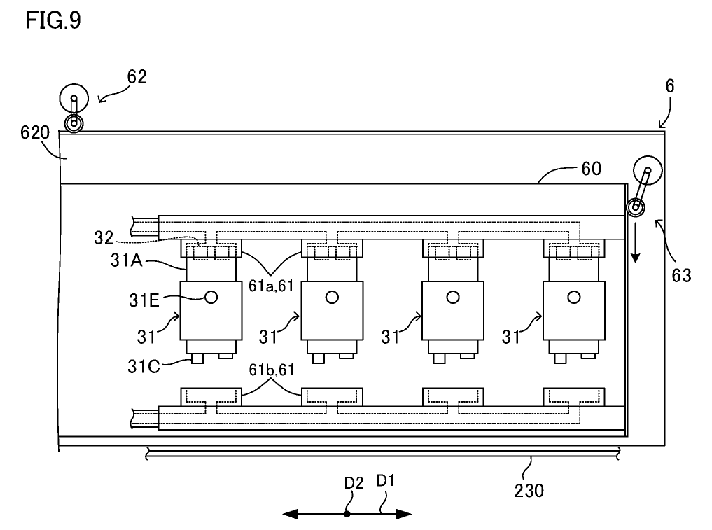

The inkjet recording apparatus 10 further includes a nozzle cover device 6 (see FIG. 1, FIG. 7 and FIG. 9). The nozzle cover device 6 has caps 61 that cover the plurality of nozzles 32 in each of the inkjet heads 31 (see FIG. 7 and FIG. 9).

The nozzle cover device 6 is switchable between a nozzle closed state in which the plurality of nozzles 32 of each inkjet head 31 are covered with the caps 61 and a nozzle open state in which the plurality of nozzles 32 of each inkjet head 31 are opened.

FIG. 5 and FIG. 6 show the nozzle cover device 6 in the nozzle open state, and FIG. 7 and FIG. 9 show the nozzle cover device 6 in the nozzle closed state.

FIG. 7 shows the nozzle cover device 6 in a first nozzle closed state. The first nozzle closed state is a state in which the plurality of nozzles 32 of each of the inkjet heads 31 are covered with the caps 61 when the plurality of inkjet heads 31 are in the first posture.

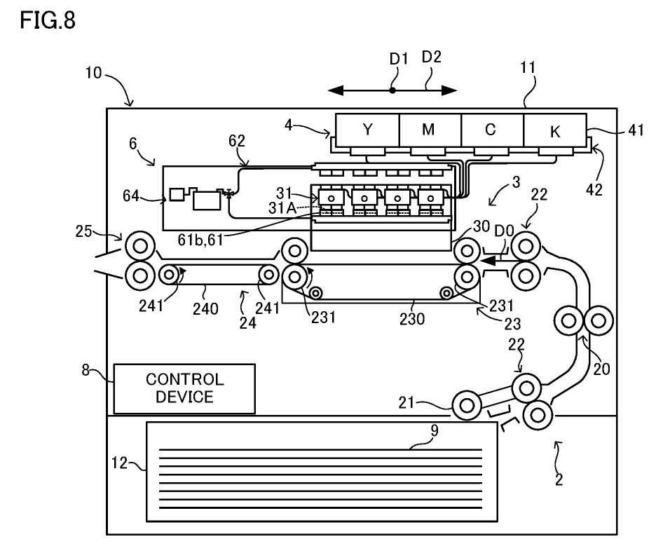

FIG. 8 shows the nozzle cover device 6 in a second nozzle closed state. The second nozzle closed state is a state in which the plurality of nozzles 32 of each of the inkjet heads 31 are covered with the caps 61 when the plurality of inkjet heads 31 are in the second posture.

The nozzle cover device 6 is selectively switchable between the nozzle open state, the first nozzle closed state, and the second nozzle closed state.

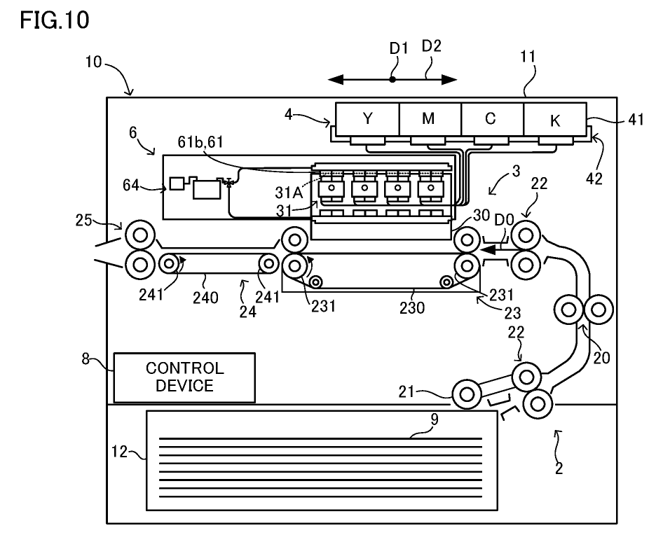

In the present embodiment, the caps 61 include a first cap 61a and a second cap 61b (see FIG. 1 and FIG. 7 to FIG. 10). The first caps 61a cover the plurality of nozzles 32 of each of the inkjet heads 31 when the plurality of inkjet heads 31 are in the first posture (see FIG. 7 and FIG. 8). The second caps 61b cover the plurality of nozzles 32 of each of the inkjet heads 31 when the plurality of inkjet heads 31 are in the second posture (see FIG. 9 and FIG. 10).

The nozzle cover device 6 includes a cap support 60, a main cap moving mechanism 62, and a sub-cap moving mechanism 63. The cap support 60 supports the caps 61. The first caps 61a and the second caps 61b are fixed to the cap support 60.

The main cap moving mechanism 62 moves the cap support 60 between a retreat position and a coverable position. FIG. 5 and FIG. 6 show a state in which the cap support 60 is in the retreat position, and FIG. 7 and FIG. 9 show a state in which the cap support 60 is in the coverable position.

When the cap support 60 is in the coverable position, one of the first caps 61a and the second caps 61b face the plurality of nozzles 32 of each of the inkjet heads 31 (see FIG. 7 and FIG. 9). The retreat position is a position farther away from the plurality of inkjet heads 31 than the coverable position (see FIG. 5 and FIG. 6).

In the present embodiment, the main cap moving mechanism 62 moves the cap support 60 along the first direction D1. The main cap moving mechanism 62 moves the cap support 60 when the plurality of inkjet heads 31 are in the maintenance position.

For example, the main cap moving mechanism 62 includes a base member 620, a third motor 62a, and a third gear mechanism 62b (see FIG. 7 and FIG. 9). The base member 620 supports the cap support 60 and is supported so as to be movable along the first direction D1.

The third gear mechanism 62b converts the rotational motion of the third motor 62a into linear motion along the first direction D1 and transmits the linear motion to the base member 620.

In the example shown in FIG. 7 and FIG. 9, the third gear mechanism 62b is a rack and pinion mechanism. Depending on the rotation direction of the third motor 62a, the cap support 60 moves from one of the retreat position and the coverable position to the other.

The base member 620 supports the cap support 60 so as to be movable in the up-down direction. The sub-cap moving mechanism 63 moves the cap support 60 upward or downward under a condition in which the plurality of inkjet heads 31 are in the maintenance position and the cap support 60 is in the coverable position.

When each of the inkjet heads 31 is in the first posture, the sub cap moving mechanism 63 moves the cap support 60 upward, causing the nozzle cover device 6 to enter the nozzle closed state (see FIG. 7 and FIG. 8).

On the other hand, when each of the inkjet heads 31 is in the second posture, the sub-cap moving mechanism 63 moves the cap support 60 downward, causing the nozzle cover device 6 to be in the nozzle closed state (see FIG. 9 and FIG. 10).

The nozzle cover device 6 further includes a liquid suction device 64 (see FIGS. 1, 8 and 10, ). The liquid suction device 64 sucks and recovers the liquid flowing from the plurality of nozzles 32 into the caps 61 when the nozzle cover device 6 is in the nozzle closed state.

For example, the liquid suction device 64 includes a suction pump, a recovery tank, and a recovery tube. The recovery tube is connected to the caps 61 and the recovery tank. The suction pump reduces the pressure in the recovery tank by sucking air from within the recovery tank. Thus, the liquid flowing into the caps 61 flows into the recovery tank through the recovery tube.

The CPU 81 of the control device 8 includes a maintenance control portion 8d as one of the plurality of processing modules (see FIG. 3). The maintenance control portion 8d controls the head driving device 30 and the nozzle cover device 6.

The maintenance control portion 8d executes a first maintenance control or a second maintenance control when a predetermined head maintenance condition is met.

In the present embodiment, the head maintenance condition includes one or both of an instruction input condition and a temperature condition.

The instruction input condition is a condition that a specific instruction is input to the operation device 801 or the communication device 85. The operation device 801 and the communication device 85 are each an example of an input device.

For example, the specific instruction includes an ink filling instruction, a storage liquid filling instruction, and an air bubble discharge instruction. The ink filling instruction is an instruction to execute a process of replacing the storage liquid in the storage portion 31B with the ink R1. The storage liquid filling instruction is an instruction to execute a process of replacing the ink R1 in the storage portion 31B with the storage liquid. The air bubble discharge instruction is an instruction to execute a process of discharging air bubbles in the storage portion 31B to the outside of the storage portion 31B.

When the ink filling instruction is input, the ink tank 41 is attached to the ink supply device 4 in advance. On the other hand, when the storage liquid filling instruction is input, a storage liquid tank that contains the storage liquid is attached to the ink supply device 4 in place of the ink tank 41.

The temperature condition is a condition that a temperature detected by the temperature sensor 37 that detects the temperature of each inkjet head 31 exceeds an allowable range. In each inkjet head 31, in a case in which air bubbles have been generated in the storage portion 31B, the temperature detected by the temperature sensor 37 tends to be higher than normal.

The temperature condition is an example of a condition that indicates that the relatively large air bubbles have been generated in the storage portion 31B. For example, the allowable range of the temperature detected by the temperature sensor 37 is set according to power supplied to the heater 36.

In the following description, the ink R1 or the storage liquid supplied to each inkjet head 31 from a tank mounted in the ink supply device 4 when the head maintenance conditions are met will be referred to as a supply liquid.

A case where the specific gravity of the ink R1 is greater than the specific gravity of the storage liquid will be described below. In a case in which the specific gravity of the ink R1 is greater than the specific gravity of the storage liquid, when the stored liquid replacement process is executed while each of the inkjet heads 31 is in the first posture, there is a risk that the storage liquid will remain in the storage portion 31B.

In a case in which the instruction input condition that the storage liquid filling instruction has been input is satisfied, the maintenance control portion 8d executes first nozzle maintenance control.

The first nozzle maintenance control includes a first posture transition control, a nozzle closing control, a liquid supply control, and a liquid suction control.

The first posture transition control is a control for causing the head driving device 30 to execute an operation of holding each of the inkjet heads 31 in the first posture at the maintenance position.

The nozzle closing control is a control for switching the nozzle cover device 6 to the nozzle closed state. By executing the first posture transition control and the nozzle closing control, the nozzle cover device 6 is brought into the first nozzle closed state (see FIG. 7 and FIG. 8).

The liquid supply control and the liquid suction control in the first nozzle maintenance control are executed when the nozzle cover device 6 is in the first nozzle closed state.

The liquid supply control is a control for supplying the supply liquid to the storage portion 31B of each inkjet head 31 by operating the ink supply device 4. The suction control is a control for operating the liquid suction device 64. The maintenance control portion 8d executes the liquid supply control and the liquid suction control in parallel.

By executing the first nozzle maintenance control corresponding to the storage liquid filling instruction, a state in which the storage liquid, which has a relatively low specific gravity, forms an upper layer and the ink R1 forms a lower layer in the storage portion 31B is easily maintained. Therefore, the ink R1 does not remain in the storage portion 31B, and the storage liquid is filled into the storage portion 31B.

On the other hand, in a case in which the instruction input condition is satisfied, that is, the ink filling instruction or the air bubble discharge instruction has been input, the maintenance control portion 8d executes a second nozzle maintenance control. Similarly, in a case in which the temperature condition is met, the maintenance control portion 8d also executes the second nozzle maintenance control.

The second nozzle maintenance control includes a second posture transition control, the nozzle closing control, the liquid supply control, and the liquid suction control.

The second posture transition control is a control for causing the head driving device 30 to execute an operation of pivoting each of the inkjet heads 31 to the second posture at the maintenance position.

By executing the second posture transition control and the nozzle closing control, the nozzle cover device 6 is brought into the second nozzle closed state (see FIG. 9 and FIG. 10).

The liquid supply control and the liquid suction control in the second nozzle maintenance control are executed when each of the inkjet heads 31 and the nozzle cover device 6 are in the second nozzle closed state.

The maintenance control portion 8d executes the liquid supply control and the liquid suction control in parallel.

By executing the second nozzle maintenance control corresponding to the ink filling instruction, a state in which the storage liquid, which has a relatively low specific gravity, forms an upper layer and the ink R1 forms a lower layer in the storage portion 31B is easily maintained. Therefore, the storage portion 31B is filled with the ink R1 without the storage liquid remaining in the storage portion 31B.

In addition, when the first nozzle maintenance control corresponding to the air bubble discharge instruction is executed, the air bubbles rise in the storage portion 31B and are pushed upward by the supply liquid. Therefore, the air bubbles in the storage portion 31B are reliably discharged to the outside of the storage portion 31B through the plurality of nozzles 32.

Note that in a case in which the specific gravity of the storage liquid is greater than the specific gravity of the ink R1, the maintenance control portion 8d executes the following control. That is, in a case in which the instruction input condition that the instruction to fill the storage liquid is input is satisfied, the maintenance control portion 8d executes the second nozzle maintenance control. On the other hand, in a case in which the command input condition that the ink filling instruction is input is satisfied, the maintenance control portion 8d executes the first nozzle maintenance control.

### Supplementary Notes

An outline of the invention extracted from the above-described embodiments will be added below. Note that the configurations and processing functions described in the following supplementary notes can be selected and combined as desired.

### Supplementary Note 1

An inkjet recording apparatus including: an ink supply device configured to supply ink; an inkjet head arranged above a sheet conveying path, the inkjet head having a storage portion configured to temporarily store the ink supplied by the ink supply device and a plurality of nozzles configured to eject the ink supplied from the storage portion onto a sheet conveyed along a first direction on the sheet conveying path; and a head driving device configured to pivot the inkjet head around a pivot shaft along a second direction crossing the first direction between a first posture in which the plurality of nozzles face the sheet conveying path and a second posture in which the plurality of nozzles face upward.

### Supplementary Note 2

The inkjet recording apparatus according to Supplementary Note 1, including: a nozzle cover device having caps configured to cover the plurality of nozzles in the inkjet head, the nozzle cover device being able to pivot between a nozzle closed state in which the plurality of nozzles are covered by the caps and a nozzle open state in which the plurality of nozzles are opened; and a control device configured to control the ink supply device, the inkjet head, the head driving device, and the nozzle cover device; wherein the nozzle cover device is capable of covering the plurality of nozzles with the caps when the inkjet head is in the second posture; and the control device executes control to switch the nozzle cover device to the nozzle closed state when a predetermined head maintenance condition is satisfied, control to cause the head drive device to pivot the inkjet head to the second posture, and control to operate the ink supply device under a situation where the nozzle cover device is in the nozzle closed state and the inkjet head is in the second posture.

### Supplementary Note 3

The inkjet recording apparatus according to Supplementary Note 2, wherein the head maintenance condition includes: an instruction input condition that a specific instruction is input to the input device; and a temperature condition in which a temperature detected by a temperature sensor configured to detect temperature of the inkjet head exceeds an allowable range.

### Supplementary Note 4

The inkjet recording apparatus according to any one of Supplementary Notes 1 to 3; wherein the inkjet head has a pressure adjusting valve configured to adjust pressure inside the storage portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An inkjet recording apparatus comprising:
an ink supply device configured to supply ink;
an inkjet head arranged above a sheet conveying path, the inkjet head having a storage portion configured to temporarily store the ink supplied by the ink supply device and a plurality of nozzles configured to eject the ink supplied from the storage portion onto a sheet conveyed along a first direction on the sheet conveying path; and
a head driving device configured to pivot the inkjet head around a pivot shaft along a second direction crossing the first direction between a first posture in which the plurality of nozzles face the sheet conveying path and a second posture in which the plurality of nozzles face upward.

2. The inkjet recording apparatus according to claim 1, wherein
a nozzle cover device having caps configured to cover the plurality of nozzles in the inkjet head, the nozzle cover device being able to pivot between a nozzle closed state in which the plurality of nozzles are covered by the caps and a nozzle open state in which the plurality of nozzles are opened; and
a control device configured to control the ink supply device, the inkjet head, the head driving device, and the nozzle cover device; wherein
the nozzle cover device is capable of covering the plurality of nozzles with the caps when the inkjet head is in the second posture; and
the control device executes control to switch the nozzle cover device to the nozzle closed state when a predetermined head maintenance condition is satisfied, control to cause the head drive device to pivot the inkjet head to the second posture, and control to operate the ink supply device under a situation where the nozzle cover device is in the nozzle closed state and the inkjet head is in the second posture.

3. The inkjet recording apparatus according to claim 2, wherein
the head maintenance condition includes:
an instruction input condition that a specific instruction is input to the input device; and
a temperature condition in which a temperature detected by a temperature sensor configured to detect temperature of the inkjet head exceeds an allowable range.

4. The inkjet recording apparatus according to claim 1, wherein
the inkjet head has a pressure adjusting valve configured to adjust pressure inside the storage portion.
